(19) United States
(12) Patent Application Publication
(10) Pub. No.: US 2020/0098491 A1
(43) Pub. Date: Mar. 26, 2020

(54) SUPERCONDUCTING WIRE, METHOD FOR MANUFACTURING SUPERCONDUCTING WIRE, SUPERCONDUCTING COIL, SUPERCONDUCTING MAGNET, AND SUPERCONDUCTING DEVICE

(71) Applicant: Sumitomo Electric Industries, Ltd., Osaka-shi, Osaka (JP)

(72) Inventors: Kotaro OHKI, Osaka-shi, Osaka (JP); Tatsuoki NAGAISHI, Osaka-shi, Osaka (JP); Takashi YAMAGUCHI, Osaka-shi, Osaka (JP)

(73) Assignee: Sumitomo Electric Industries, Ltd., Osaka-shi, Osaka (JP)

(21) Appl. No.: 16/495,503

(22) PCT Filed: May 19, 2017
(86) PCT No.: PCT/JP2017/018881

§ 371 Date: Sep. 19, 2019

(51) Int. Cl. H01B 12/06; H01F 6/06; H01R 4/68

(52) U.S. Cl. CPC H01B 12/06; H01R 4/68; H01F 6/06

(57) ABSTRACT

A superconducting wire includes: a first wire including a first superconducting material layer having a first main surface; a second wire including a second superconducting material layer having a second main surface; a third wire including a third superconducting material layer having a third main surface; a first superconducting material joining layer that joins the first main surface to the second main surface; and a second superconducting material joining layer that joins the second main surface to the third main surface. The first wire has a first end surface. The third wire has a second end surface. The second end surface faces the first end surface with a space being interposed between the second end surface and the first end surface. The space is more than or equal to 10 nm and less than 1 mm.

### TECHNICAL FIELD

The present invention relates to a superconducting wire, a method for manufacturing the superconducting wire, a superconducting coil, a superconducting magnet, and a superconducting device.

### BACKGROUND ART

Japanese Patent Laying-Open No. 2007-266149 (Patent Literature 1) discloses a superconducting wire including: two wires each including an oxide superconducting material layer; and a short-length joining member including an oxide superconducting material layer. In the superconducting wire disclosed in Patent Literature 1, the end surfaces of the two wires are in contact with each other and the two wires are connected to each other via the joining member.

### CITATION LIST

### Patent Literature

PTL 1: Japanese Patent Laying-Open No. 2007-266149

### SUMMARY OF INVENTION

A superconducting wire according to one embodiment of the present invention includes: a first wire including a first superconducting material layer having a first main surface; a second wire including a second superconducting material layer having a second main surface; a third wire including a third superconducting material layer having a third main surface; a first superconducting material joining layer that joins a first portion of the first main surface to a second portion of the second main surface; and a second superconducting material joining layer that joins a third portion of the second main surface to a fourth portion of the third main surface. The first wire has a first end surface. The third wire has a second end surface. A second length of the second wire in a longitudinal direction of the second wire is shorter than a first length of the first wire in a longitudinal direction of the first wire and a third length of the third wire in a longitudinal direction of the third wire. The second end surface faces the first end surface with a space being interposed between the second end surface and the first end surface. The space is more than or equal to 10 nm and less than 1 mm.

A method for manufacturing a superconducting wire according to one embodiment of the present invention includes: preparing a first wire including a first superconducting material layer having a first main surface, a second wire including a second superconducting material layer having a second main surface, and a third wire including a third superconducting material layer having a third main surface. The first wire has a first end surface. The third wire has a second end surface. A second length of the second wire in a longitudinal direction of the second wire is shorter than a first length of the first wire in a longitudinal direction of the first wire and a third length of the third wire in a longitudinal direction of the third wire. The method for manufacturing the superconducting wire according to one embodiment of the present invention further includes: forming first fine crystals on at least one of a first portion of the first main surface and a second portion of the second main surface, and second fine crystals on at least one of a third portion of the second main surface and a fourth portion of the third main surface; and placing the second wire on the first wire with the first fine crystals being interposed therebetween and on the third wire with the second fine crystals being interposed therebetween. The placing of the second wire on the first wire with the first fine crystals being interposed therebetween and on the third wire with the second fine crystals being interposed therebetween includes stacking the first portion of the first wire and the second portion of the second wire with the first fine crystals being interposed therebetween, and stacking the third portion of the second wire and the fourth portion of the third wire with the second fine crystals being interposed therebetween. The second end surface faces the first end surface with a space being interposed between the second end surface and the first end surface. The space is more than or equal to 10 nm and less than 1 mm. The method for manufacturing the superconducting wire according to one embodiment of the present invention further includes: generating a first superconducting material joining layer and a second superconducting material joining layer from the first fine crystals and the second fine crystals respectively by applying pressure and heat to the first wire, the first fine crystals, the second wire, the second fine crystals, and the third wire; and performing oxygen annealing onto the first superconducting material layer, the first superconducting material joining layer, the second superconducting material layer, the second superconducting material joining layer, and the third superconducting material layer.

A superconducting coil according to one embodiment of the present invention includes the above-described superconducting wire. The superconducting wire is wound around a center axis of the superconducting coil. A superconducting magnet according to one embodiment of the present invention includes: the above-described superconducting coil; a cryostat configured to store the above-described superconducting coil; and a refrigerator configured to cool the above-described superconducting coil. A superconducting device according to one embodiment of the present invention includes the above-described superconducting magnet.

### BRIEF DESCRIPTION OF DRAWINGS

FIG. 1 is a schematic cross sectional view of a superconducting wire according to a first embodiment.

FIG. 2 is a partial enlarged schematic cross sectional view of a region II, shown in FIG. 1, of the superconducting wire according to the first embodiment.

FIG. 3 is a partial enlarged schematic cross sectional view of a region III, shown in FIG. 1, of the superconducting wire according to the first embodiment.

FIG. 4 shows a flowchart of a method for manufacturing the superconducting wire according to the first embodiment.

FIG. 5 shows a flowchart of a step of forming first fine crystals in the method for manufacturing the superconducting wire according to the first embodiment.

FIG. 6 shows a two-dimensional X-ray diffraction image of a first superconducting material joining layer after the fine crystal forming step in the method for manufacturing the superconducting wire according to the first embodiment.

FIG. 7 shows a two-dimensional X-ray diffraction image of the first superconducting material joining layer after a heat and pressure applying step in the method for manufacturing the superconducting wire according to the first embodiment.

FIG. 8 is a schematic cross sectional view of a superconducting magnet according to a second embodiment.

FIG. 9 is a schematic side view of a superconducting device according to a third embodiment.

### DETAILED DESCRIPTION

### Problem to be Solved by the Present Disclosure

A first object of the present disclosure is to provide a superconducting wire in which detachment strength and superconducting critical current are increased. A second object of the present disclosure is to provide a method for manufacturing a superconducting wire, by which a superconducting wire in which detachment strength and superconducting critical current are increased can be manufactured in a short time. A third object of the present disclosure is to provide a superconducting coil, a superconducting magnet, and a superconducting device, each of which includes such a superconducting wire.

### Advantageous Effect of the Present Disclosure

According to the superconducting wire according to one embodiment of the present invention, detachment strength and superconducting critical current in the superconducting wire can be increased. According to the method for manufacturing the superconducting wire according to one embodiment of the present invention, a superconducting wire in which detachment strength and superconducting critical current are increased can be manufactured in a short time. The superconducting coil according to one embodiment of the present invention has high reliability and can generate a strong magnetic field. The superconducting magnet according to one embodiment of the present invention has high reliability and can generate a strong magnetic field. The superconducting device according to one embodiment of the present invention has high reliability and can generate a strong magnetic field.

### Description of Embodiments

First, embodiments of the present invention are listed and described.

(1) A superconducting wire 1 according to one embodiment of the present invention includes: a first wire 10 including a first superconducting material layer 13 having a first main surface 13s; a second wire 20 including a second superconducting material layer 23 having a second main surface 23s; a third wire 30 including a third superconducting material layer 33 having a third main surface 33s; a first superconducting material joining layer 40 that joins a first portion 17 of first main surface 13s to a second portion 27 of second main surface 23s; and a second superconducting material joining layer 42 that joins a third portion 28 of second main surface 23s to a fourth portion 38 of third main surface 33s. First wire 10 has a first end surface 10e. Third wire 30 has a second end surface 30e. A second length of second wire 20 in a longitudinal direction of second wire 20 is shorter than a first length of first wire 10 in a longitudinal direction of first wire 10 and a third length of third wire 30 in a longitudinal direction of third wire 30. Second end surface 30e faces first end surface 10e with a space G being interposed between second end surface 30e and first end surface 10e. Space G is more than or equal to 10 nm and less than 1 mm.

In superconducting wire 1 according to (1), space G between first end surface 10e and second end surface 30e is more than or equal to 10 nm. Superconducting wire 1 according to (1) is configured such that oxygen can be sufficiently supplied to first superconducting material joining layer 40, second superconducting material joining layer 42, first superconducting material layer 13, second superconducting material layer 23, and third superconducting material layer 33. Superconducting critical current I_{c} is increased at a first superconducting joining portion between first superconducting material layer 13 and second superconducting material layer 23 with first superconducting material joining layer 40 being interposed therebetween, and superconducting critical current I_{c} is increased at a second superconducting joining portion between second superconducting material layer 23 and third superconducting material layer 33 with second superconducting material joining layer 42 being interposed therebetween. Superconducting critical current I_{c} of superconducting wire 1 according to (1) is increased.

In superconducting wire 1 according to (1), since space G between first end surface 10e and second end surface 30e is less than 1 mm, a first joining area of the first superconducting joining portion can be increased between first superconducting material layer 13 and second superconducting material layer 23 with first superconducting material joining layer 40 being interposed therebetween, and a second joining area of the second superconducting joining portion can be increased between second superconducting material layer 23 and third superconducting material layer 33 with second superconducting material joining layer 42 being interposed therebetween. First detachment strength is increased between first wire 10 and second wire 20 and second detachment strength is increased between second wire 20 and third wire 30 in superconducting wire 1 according to (1).

It should be noted that in superconducting wire 1 according to one embodiment of the present invention, first wire 10 and third wire 30 may be the same wire. For example, first portion 17 of first wire 10 may constitute one end portion of one wire and fourth portion 38 of third wire 30 may constitute the other end portion of the wire.

(2) In superconducting wire 1 according to (1), first superconducting material layer 13 is exposed at first end surface 10e. Third superconducting material layer 33 is exposed at second end surface 30e. Hence, superconducting wire 1 according to (2) is configured such that oxygen can be sufficiently supplied to first superconducting material joining layer 40, second superconducting material joining layer 42, first superconducting material layer 13, second superconducting material layer 23, and third superconducting material layer 33. Superconducting critical current of superconducting wire 1 according to (2) is increased.

(3) Superconducting wire 1 according to (1) or (2) further includes: a first conductive member 50; and a second conductive member 52. First wire 10 includes a first protective layer 14 in contact with first superconducting material layer 13, and a first stabilization layer 15 in contact with first protective layer 14. Second wire 20 includes a second protective layer 24, and a second stabilization layer 25 in contact with second protective layer 24. Third wire 30 includes a third protective layer 34 in contact with third superconducting material layer 33, and a third stabilization layer 35 in contact with third protective layer 34. First conductive member 50 connects first protective layer 14 to second protective layer 24, and connects first stabilization layer 15 to second stabilization layer 25. Second conductive member 52 connects second protective layer 24 to third protective layer 34, and connects second stabilization layer 25 to third stabilization layer 35.

In superconducting wire 1 according to (3), each of first protective layer 14, second protective layer 24, third protective layer 34, first stabilization layer 15, second stabilization layer 25, third stabilization layer 35, first conductive member 50, and second conductive member 52 functions as a bypass through which current having flown through first superconducting material layer 13, second superconducting material layer 23, third superconducting material layer 33, first superconducting material joining layer 40, and second superconducting material joining layer 42 is changed to flow when at least one of first superconducting material layer 13, second superconducting material layer 23, third superconducting material layer 33, first superconducting material joining layer 40, and second superconducting material joining layer 42 makes transition from the superconducting state to the normal conducting state. Superconducting wire 1 can be prevented from being damaged when at least one of first superconducting material layer 13, second superconducting material layer 23, third superconducting material layer 33, first superconducting material joining layer 40, and second superconducting material joining layer 42 makes transition from the superconducting state to the normal conducting state.

(4) A method for manufacturing a superconducting wire 1 according to one embodiment of the present invention includes: preparing a first wire 10 including a first superconducting material layer 13 having a first main surface 13s, a second wire 20 including a second superconducting material layer 23 having a second main surface 23s, and a third wire 30 including a third superconducting material layer 33 having a third main surface 33s. First wire 10 has a first end surface 10e. Third wire 30 has a second end surface 30e. A second length of second wire 20 in a longitudinal direction of second wire 20 is shorter than a first length of first wire 10 in a longitudinal direction of first wire 10 and a third length of third wire 30 in a longitudinal direction of third wire 30. The method for manufacturing superconducting wire 1 according to one embodiment of the present invention further includes: forming first fine crystals on at least one of a first portion 17 of first main surface 13s and a second portion 27 of second main surface 23s, and second fine crystals on at least one of a third portion 28 of second main surface 23s and a fourth portion 38 of third main surface 33s; and placing second wire 20 on first wire 10 with the first fine crystals being interposed therebetween and on third wire 30 with the second fine crystals being interposed therebetween. The placing of second wire 20 on first wire 10 with the first fine crystals being interposed therebetween and on third wire 30 with the second fine crystals being interposed therebetween includes stacking first portion 17 of first wire 10 and second portion 27 of second wire 20 with the first fine crystals being interposed therebetween, and stacking third portion 28 of second wire 20 and fourth portion 38 of third wire 30 with the second fine crystals being interposed therebetween. Second end surface 30e faces first end surface 10e with a space G being interposed between second end surface 30e and first end surface 10e. Space G is more than or equal to 10 nm and less than 1 mm. The method for manufacturing superconducting wire 1 according to one embodiment of the present invention further includes: generating a first superconducting material joining layer 40 and a second superconducting material joining layer 42 from the first fine crystals and the second fine crystals respectively by applying pressure and heat to first wire 10, the first fine crystals, second wire 20, the second fine crystals, and third wire 30; and performing oxygen annealing onto first superconducting material layer 13, first superconducting material joining layer 40, second superconducting material layer 23, second superconducting material joining layer 42, and third superconducting material layer 33.

In the method for manufacturing superconducting wire 1 according to (4), space G between first end surface 10e and second end surface 30e is more than or equal to 10 nm. Hence, in a short time, oxygen can be sufficiently supplied to first superconducting material joining layer 40, second superconducting material joining layer 42, first superconducting material layer 13, second superconducting material layer 23, and third superconducting material layer 33. Superconducting critical current I_{c} is increased at a first superconducting joining portion between first superconducting material layer 13 and second superconducting material layer 23 with first superconducting material joining layer 40 being interposed therebetween, and superconducting critical current I_{c} is increased at a second superconducting joining portion between second superconducting material layer 23 and third superconducting material layer 33 with second superconducting material joining layer 42 being interposed therebetween. According to the method for manufacturing superconducting wire 1 according to (4), superconducting wire 1 in which superconducting critical current I_{c} is increased can be manufactured in a short time.

In the method for manufacturing superconducting wire 1 according to (4), since space G between first end surface 10e and second end surface 30e is less than 1 mm, a first joining area of the first superconducting joining portion can be increased between first superconducting material layer 13 and second superconducting material layer 23 with first superconducting material joining layer 40 being interposed therebetween, and a second joining area of the second superconducting joining portion can be increased between second superconducting material layer 23 and third superconducting material layer 33 with second superconducting material joining layer 42 being interposed therebetween. According to the method for manufacturing superconducting wire 1 according to (4), there can be manufactured superconducting wire 1 in which first detachment strength is increased between first wire 10 and second wire 20 and second detachment strength is increased between second wire 20 and third wire 30.

It should be noted that in the method for manufacturing superconducting wire 1 according to one embodiment of the present invention, first wire 10 and third wire 30 may be the same wire. For example, first portion 17 of first wire 10 may constitute one end portion of one wire and fourth portion 38 of third wire 30 may constitute the other end portion of the wire.

(5) A superconducting coil 70 according to one embodiment of the present invention includes any one of superconducting wires 1 according to (1) to (3). Any one of superconducting wires 1 according to (1) to (3) is wound around a center axis of superconducting coil 70. Superconducting coil 70 according to (5) has high reliability and can generate a strong magnetic field.

(6) A superconducting magnet 100 according to one embodiment of the present invention includes: superconducting coil 70 according to (5); a cryostat 105 configured to store superconducting coil 70; and a refrigerator 102 configured to cool superconducting coil 70. Superconducting magnet 100 according to (6) has high reliability and can generate a strong magnetic field.

(7) A superconducting device 200 according to one embodiment of the present invention includes superconducting magnet 100 according to (6). Superconducting device 200 according to (7) has high reliability and can generate a strong magnetic field.

### Details of Embodiments of the Present Invention

Hereinafter, a superconducting wire 1 according to an embodiment of the present invention will be described. It should be noted that the same configurations are given the same reference characters and are not described repeatedly. Moreover, at least parts of configurations of the embodiments described below may be appropriately combined.

### First Embodiment

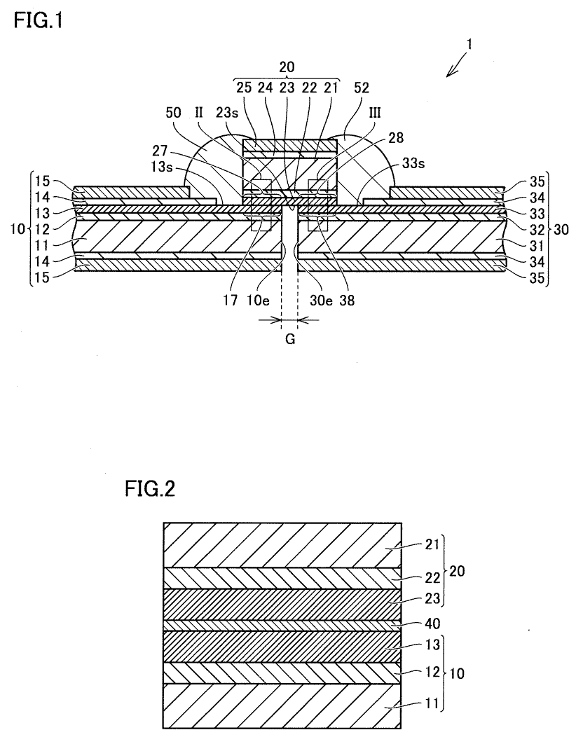

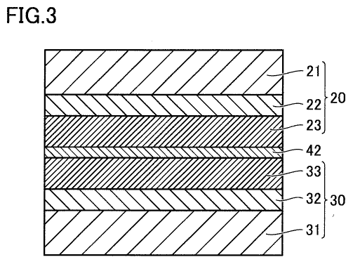

With reference to FIG. 1 to FIG. 3, superconducting wire 1 according to the present embodiment mainly includes a first wire 10, a second wire 20, a third wire 30, a first superconducting material joining layer 40, and a second superconducting material joining layer 42. Superconducting wire 1 according to the present embodiment may further include a first conductive member 50 and a second conductive member 52.

First wire 10 includes a first superconducting material layer 13 having a first main surface 13s. Particularly, first wire 10 may include: a first metal substrate 11; a first intermediate layer 12 provided on first metal substrate 11; first superconducting material layer 13 provided on first intermediate layer 12; a first protective layer 14 provided on first main surface 13s of first superconducting material layer 13; and a first stabilization layer 15 provided on first protective layer 14.

Second wire 20 includes a second superconducting material layer 23 having a second main surface 23s. Particularly, second wire 20 may include: a second metal substrate 21; a second intermediate layer 22 provided on second metal substrate 21;

second superconducting material layer 23 provided on second intermediate layer 22; a second protective layer 24; and a second stabilization layer 25 provided on second protective layer 24. The second length of second wire 20 in the longitudinal direction of second wire 20 is shorter than the first length of first wire 10 in the longitudinal direction of first wire 10 and the third length of third wire 30 in the longitudinal direction of third wire 30. Second wire 20 has a shorter length than that of first wire 10, and has a shorter length than that of third wire 30.

Third wire 30 includes a third superconducting material layer 33 having a third main surface 33s. Particularly, third wire 30 may include: a third metal substrate 31; a third intermediate layer 32 provided on third metal substrate 31; third superconducting material layer 33 provided on third intermediate layer 32; a third protective layer 34 provided on third main surface 33s of third superconducting material layer 33; and a third stabilization layer 35 provided on third protective layer 34. Third wire 30 may be configured in the same manner as first wire 10. In superconducting wire 1 of the present embodiment, first wire 10 and third wire 30 may be the same wire. For example, first portion 17 of first wire 10 may constitute one end portion of one wire and fourth portion 38 of third wire 30 may constitute the other end portion of the wire.

Each of first metal substrate 11, second metal substrate 21, and third metal substrate 31 may be an orientation metal substrate. The orientation metal substrate refers to a metal substrate having a surface in which a crystal orientation is aligned. The orientation metal substrate may be, for example, a clad type metal substrate in which a nickel layer, a copper layer, and the like are disposed on a SUS or Hastelloy® base metal substrate.

First intermediate layer 12 has very low reactivity with first superconducting material layer 13. For first intermediate layer 12, it is possible to use a material that does not decrease the superconducting property of first superconducting material layer 13. Second intermediate layer 22 has very low reactivity with second superconducting material layer 23. For second intermediate layer 22, it is possible to use a material that does not decrease the superconducting property of second superconducting material layer 23. Third intermediate layer 32 has very low reactivity with third superconducting material layer 33. For third intermediate layer 32, it is possible to use a material that does not decrease the superconducting property of third superconducting material layer 33. Each of first intermediate layer 12, second intermediate layer 22, and third intermediate layer 32 may be composed of, for example, at least one of YSZ (yttria stabilized zirconia), CeO₂ (cerium oxide), MgO (magnesium oxide), Y₂O₃ (yttrium oxide), Al₂O₃ (aluminum oxide), LaMnO₃ (lanthanum manganese oxide), Gd₂Zr₂O₇ (gadolinium zirconate) and SrTiO₃ (strontium titanate). Each of first intermediate layer 12, second intermediate layer 22, and third intermediate layer 32 may be constituted of a plurality of layers.

When the SUS substrate or the Hastelloy substrate is used as each of first metal substrate 11, second metal substrate 21, and third metal substrate 31, each of first intermediate layer 12, second intermediate layer 22, and third intermediate layer 32 may be a crystal orientation layer formed by an IBAD (Ion Beam Assisted Deposition) method, for example. When first metal substrate 11 has a crystal orientation at its surface, first intermediate layer 12 may alleviate a crystal orientation difference between first metal substrate 11 and first superconducting material layer 13. When second metal substrate 21 has a crystal orientation at its surface, second intermediate layer 22 may alleviate a crystal orientation difference between second metal substrate 21 and second superconducting material layer 23. When third metal substrate 31 has a crystal orientation at its surface, third intermediate layer 32 may alleviate a crystal orientation difference between third metal substrate 31 and third superconducting material layer 33.

First superconducting material layer 13 is a portion of first wire 10 in which superconducting current flows. Second superconducting material layer 23 is a portion of second wire 20 in which superconducting current flows. Third superconducting material layer 33 is a portion of third wire 30 in which superconducting current flows. Each of first superconducting material layer 13, second superconducting material layer 23, and third superconducting material layer 33 may be composed of, but not particularly limited to, an oxide superconducting material. Particularly, first superconducting material layer 13 may be composed of RE1₁Ba₂Cu₃O_{y1} (6.0≤y1≤8.0; RE1 represents a rare earth element). Second superconducting material layer 23 may be composed of RE2₁Ba₂Cu₃O_{y2} (6.0≤y2≤8.0; RE2 represents a rare earth element). Third superconducting material layer 33 may be composed of RE3₁Ba₂Cu₃O_{y3} (6.0≤y3≤8.0; RE3 represents a rare earth element). RE2 may be the same as or different from RE1 and RE3. RE3 may be the same as or different from RE1. More particularly, each of RE1, RE2, and RE3 may be yttrium (Y), gadolinium (Gd), dysprosium (Dy), europium (Eu), samarium (Sm), lanthanum (La), neodymium (Nd), erbium (Er), thulium (Tm), ytterbium (Yb), lutetium (Lu) or holmium (Ho). Still more particularly, each of y1, y2, and y3 may be more than or equal to 6.8 and less than or equal to 7.0.

First protective layer 14 is in contact with first superconducting material layer 13. First protective layer 14 is not provided on first portion 17 of first superconducting material layer 13 in contact with first superconducting material joining layer 40. First portion 17 of first superconducting material layer 13 is exposed from first protective layer 14. At a portion of first wire 10 except for first portion 17 of first wire 10, first protective layer 14 surrounds first superconducting material layer 13. Particularly, at the portion of first wire 10 except for first portion 17 of first wire 10, first protective layer 14 surrounds a first layered body constituted of first superconducting material layer 13, first intermediate layer 12, and first metal substrate 11. First portion 17 may be located at the first end portion (17) of first wire 10. First protective layer 14 is composed of an electrically conductive material such as silver (Ag) or a silver alloy. First protective layer 14 functions as a bypass through which current having flown through first superconducting material layer 13 is changed to flow when first superconducting material layer 13 is transitioned from the superconducting state to the normal conducting state.

Third protective layer 34 is in contact with third superconducting material layer 33. Third protective layer 34 is not provided on fourth portion 38 of third superconducting material layer 33 in contact with second superconducting material joining layer 42. Fourth portion 38 of third superconducting material layer 33 is exposed from third protective layer 34. At a portion of third wire 30 except for fourth portion 38 of third wire 30, third protective layer 34 surrounds third superconducting material layer 33. Particularly, at a portion of third wire 30 except for fourth portion 38 of third wire 30, third protective layer 34 surrounds a third layered body constituted of third superconducting material layer 33, third intermediate layer 32, and third metal substrate 31. Fourth portion 38 may be located at the fourth end portion (38) of third wire 30. Third protective layer 34 is composed of an electrically conductive material such as silver (Ag) or a silver alloy. Third protective layer 34 functions as a bypass through which current having flown through third superconducting material layer 33 is changed to flow when third superconducting material layer 33 is transitioned from the superconducting state to the normal conducting state.

First stabilization layer 15 is in contact with first protective layer 14. First stabilization layer 15 is not provided on first portion 17 of first superconducting material layer 13 in contact with first superconducting material joining layer 40. First portion 17 of first superconducting material layer 13 is exposed from first stabilization layer 15. At a portion of first wire 10 except for first portion 17 of first wire 10, first stabilization layer 15 surrounds first superconducting material layer 13. Particularly, at the portion of first wire 10 except for first portion 17 of first wire 10, first stabilization layer 15 surrounds the first layered body constituted of first superconducting material layer 13, first intermediate layer 12, and first metal substrate 11.

Third stabilization layer 35 is in contact with third protective layer 34. Third stabilization layer 35 is not provided on fourth portion 38 of third superconducting material layer 33 in contact with second superconducting material joining layer 42. Fourth portion 38 of third superconducting material layer 33 is exposed from third stabilization layer 35. At a portion of third wire 30 except for fourth portion 38 of third wire 30, third stabilization layer 35 surrounds third superconducting material layer 33. Particularly, at a portion of third wire 30 except for fourth portion 38 of third wire 30, third stabilization layer 35 surrounds the third layered body constituted of third superconducting material layer 33, third intermediate layer 32, and third metal substrate 31.

Each of first stabilization layer 15 and third stabilization layer 35 may be a metal layer having excellent electrical conductivity, such as copper (Cu) or a copper alloy, for example. Together with first protective layer 14, first stabilization layer 15 functions as a bypass through which current having flown through first superconducting material layer 13 is changed to flow when first superconducting material layer 13 is transitioned from the superconducting state to the normal conducting state. Together with third protective layer 14, third stabilization layer 35 functions as a bypass through which current having flown through third superconducting material layer 33 is changed to flow when third superconducting material layer 33 is transitioned from the superconducting state to the normal conducting state. First stabilization layer 15 and third stabilization layer 35 are respectively thicker than first protective layer 14 and third protective layer 34.

Second protective layer 24 is composed of an electrically conductive material such as silver (Ag) or a silver alloy. Second stabilization layer 25 may be a metal layer having excellent electrical conductivity, such as copper (Cu) or a copper alloy, for example. Second stabilization layer 25 is thicker than second protective layer 24.

Second protective layer 24 and second stabilization layer 25 are not provided on: second portion 27 of second superconducting material layer 23 in contact with first superconducting material joining layer 40; and third portion 28 of second superconducting material layer 23 in contact with second superconducting material joining layer 42. Second portion 27 and third portion 28 of second superconducting material layer 23 are exposed from second protective layer 24 and second stabilization layer 25. Second portion 27 may be located at the second end portion (27) of second wire 20. Third portion 28 may be located at the third end portion (28) of second wire 20. Particularly, second protective layer 24 and second stabilization layer 25 are not provided on second superconducting material layer 23. Second protective layer 24 and second stabilization layer 25 are provided on the backside surface of second metal substrate 21. The backside surface of second metal substrate 21 is a surface opposite to the front surface of second metal substrate 21 on which second superconducting material layer 23 is provided.

First wire 10 has a first end surface 10e. Third wire 30 has a second end surface 30e. Second end surface 30e faces first end surface 10e with a space G being interposed between second end surface 30e and first end surface 10e. This space G may be more than or equal to 10 nm, may be more than or equal to 100 nm, or may be more than or equal to 1 μm. This space G may be less than 1 mm, may be less than or equal to 400 μm, or may be less than or equal to 100 μm. First main surface 13s of first superconducting material layer 13 and second main surface 23s of second superconducting material layer 23 are joined to each other with first superconducting material joining layer 40 being interposed therebetween. Second main surface 23s of second superconducting material layer 23 and third main surface 33s of third superconducting material layer 33 are joined to each other with second superconducting material joining layer 42 being interposed therebetween. Second wire 20 extends over first end surface 10e of first wire 10 and second end surface 30e of third wire 30. Second superconducting material layer 23 bridges between first portion 17 of first superconducting material layer 13 and fourth portion 38 of third superconducting material layer 33. First superconducting material layer 13 extends to first end surface 10e and may be exposed at first end surface 10e. Third superconducting material layer 33 extends to second end surface 30e, and may be exposed at second end surface 30e.

First conductive member 50 connects first protective layer 14 to second protective layer 24, and connects first stabilization layer 15 to second stabilization layer 25. Although not limited particularly, first conductive member 50 may be composed of a solder. Upon occurrence of quench (phenomenon of making transition from the superconducting state to the normal conducting state) in first superconducting material joining layer 40, first conductive member 50 can serve as a bypass for current having flown through first superconducting material layer 13, second superconducting material layer 23, and first superconducting material joining layer 40. First conductive member 50 can reinforce a first superconducting joining portion between first wire 10 and second wire 20.

Second conductive member 52 connects second protective layer 24 to third protective layer 34, and connects second stabilization layer 25 to third stabilization layer 35. Although not limited particularly, second conductive member 52 may be composed of a solder. Upon occurrence of quench in second superconducting material joining layer 42, second conductive member 52 can serve as a bypass for current having flown through second superconducting material layer 23, third superconducting material layer 33, and second superconducting material joining layer 42. Second conductive member 52 can reinforce a second superconducting joining portion between second wire 20 and third wire 30.

First superconducting material joining layer 40 joins first portion 17 of first main surface 13s of first superconducting material layer 13 to second portion 27 of second main surface 23s of second superconducting material layer 23. Although not limited particularly, first superconducting material joining layer 40 may be composed of an oxide superconducting material. Particularly, first superconducting material joining layer 40 may be composed of RE3₁Ba₂Cu₃O_{y3} (6.0≤y3≤8.0; RE3 represents a rare earth element). RE3 may be the same as or different from RE1. RE3 may be the same as or different from RE2. More particularly, RE3 may be yttrium (Y), gadolinium (Gd), dysprosium (Dy), europium (Eu), samarium (Sm), lanthanum (La), neodymium (Nd), erbium (Er), thulium (Tm), ytterbium (Yb), lutetium (Lu) or holmium (Ho). Still more particularly, y3 may be more than or equal to 6.8 and less than or equal to 7.0.

Second superconducting material joining layer 42 joins third portion 28 of second main surface 23s of second superconducting material layer 23 to fourth portion 38 of third main surface 33s of third superconducting material layer 33. Third portion 28 is different from second portion 27. Although not limited particularly, second superconducting material joining layer 42 may be composed of an oxide superconducting material. Particularly, second superconducting material joining layer 42 may be composed of RE5₁Ba₂Cu₃O_{y5} (6.0≤y5≤8.0; RE5 represents a rare earth element). RE5 may be the same as or different from RE2. RE5 may be the same as or different from RE3. RE5 may be the same as or different from RE4. More particularly, RE5 may be yttrium (Y), gadolinium (Gd), dysprosium (Dy), europium (Eu), samarium (Sm), lanthanum (La), neodymium (Nd), erbium (Er), thulium (Tm), ytterbium (Yb), lutetium (Lu) or holmium (Ho). Still more particularly, y5 may be more than or equal to 6.8 and less than or equal to 7.0.

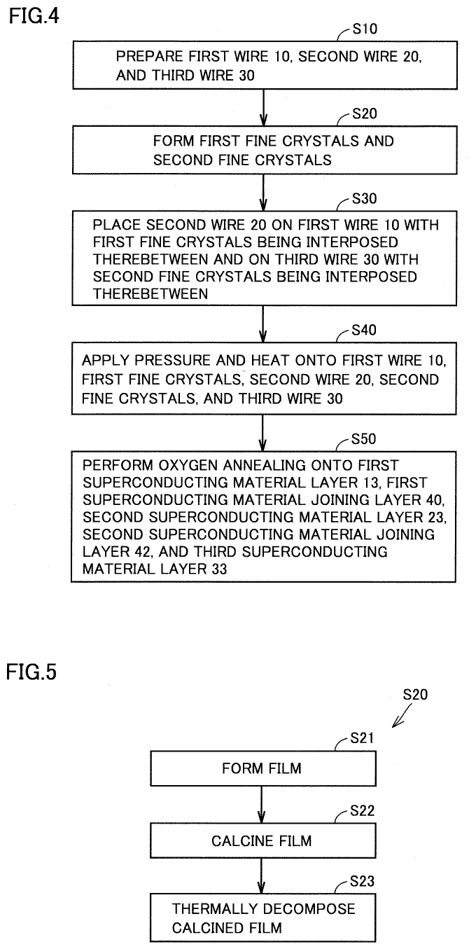

With reference to FIG. 4 and FIG. 5, the following describes a method for manufacturing superconducting wire 1 in the present embodiment.

As shown in FIG. 4, the method for manufacturing superconducting wire 1 in the present embodiment includes: preparing first wire 10 including first superconducting material layer 13 having first main surface 13s, second wire 20 including second superconducting material layer 23 having second main surface 23s, and third wire 30 including third superconducting material layer 33 having third main surface 33s (S10). First wire 10 has first end surface 10e. Third wire 30 has second end surface 30e. The second length of second wire 20 in the longitudinal direction of second wire 20 is shorter than the first length of first wire 10 in the longitudinal direction of first wire 10 and the third length of third wire 30 in the longitudinal direction of third wire 30. Second wire 20 has a shorter length than that of first wire 10, and has a shorter length than that of third wire 30.

The method for manufacturing superconducting wire 1 in the present embodiment includes forming first fine crystals of an oxide superconducting material for first superconducting material joining layer 40 on at least one of first portion 17 of first main surface 13s and second portion 27 of second main surface 23s, and forming second fine crystals of an oxide superconducting material for second superconducting material joining layer 42 on at least one of third portion 28 of second main surface 23s and fourth portion 38 of third main surface 33s (S20). The second fine crystals are formed by the same step as the step of forming the first fine crystals. With reference to FIG. 5, the following illustratively describes the step of forming the first fine crystals in the method for manufacturing superconducting wire 1 in the present embodiment.

The forming of the first fine crystals (S20) includes forming, on at least one of first portion 17 of first superconducting material layer 13 and second portion 27 of second superconducting material layer 23, a film including an organic compound of the elements of first superconducting material joining layer 40 (S21). In one example, a solution including the organic compound of the elements of first superconducting material joining layer 40 is applied onto at least one of first portion 17 of first superconducting material layer 13 and second portion 27 of second superconducting material layer 23. A specific example of the solution used herein is a source material solution in a MOD method, i.e., a solution in which an organic compound (for example, organometallic compound or organometallic complex) of the elements of RE3₁Ba₂Cu₃O_{y3}, which is a material of first superconducting material joining layer 40, is dissolved in an organic solvent. The organic compound may be an organic compound that does not include fluorine.

The forming of the first fine crystals (S20) includes calcining the film including the organic compound of the elements of first superconducting material joining layer 40 (S22). Specifically, this film is calcined at a first temperature. The first temperature is more than or equal to the decomposition temperature of the organic compound and less than or equal to the temperature at which the oxide superconducting material for first superconducting material joining layer 40 is generated. Accordingly, the organic compound included in this film is thermally decomposed and is accordingly formed into a precursor of the oxide superconducting material (hereinafter, the film including this precursor will be referred to as “calcined film”). The precursor of the oxide superconducting material includes BaCO₃, which is a carbon compound of Ba, an oxide of the rare earth element (RE3), and CuO, for example. The calcining step (S22) may be performed at the first temperature such as a temperature of about 500° C. under an atmosphere having an oxygen concentration of more than or equal to 20%, for example.

The forming of the fine crystals (S20) includes thermally decomposing the carbon compound included in the calcined film by heating the calcined film at a second temperature higher than the first temperature (S23). The second temperature may be more than or equal to 650° C. and less than or equal to 800° C., for example. The carbon compound included in the calcined film is thermally decomposed, thereby obtaining the oxide superconducting material for first superconducting material joining layer 40. The step (S23) of thermally decomposing the carbon compound included in the calcined film is performed under an atmosphere having a first oxygen concentration.

The first oxygen concentration is more than or equal to 1% and less than or equal to less than or equal to 100% (oxygen partial pressure of 1 atm). Accordingly, the first fine crystals are suppressed from growing to have an average grain size of more than 300 nm. In this way, the first fine crystals of the oxide superconducting material for first superconducting material joining layer 40 is formed on at least one of first portion 17 of first superconducting material layer 13 and second portion 27 of second superconducting material layer 23.

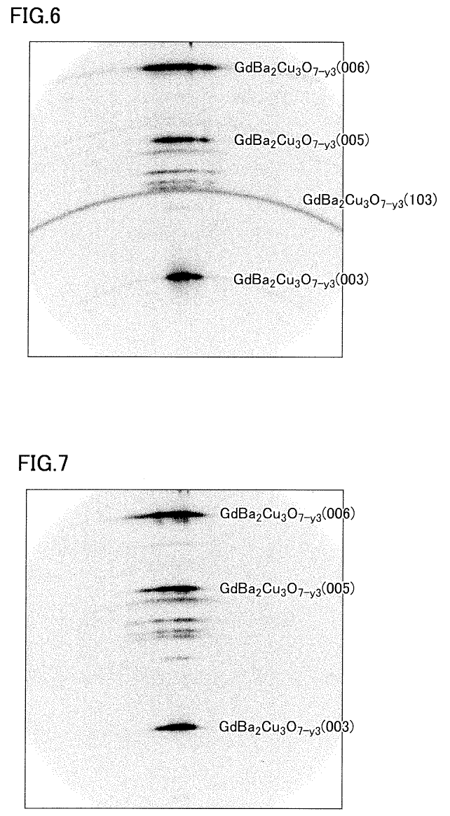

As apparent from a two-dimensional X-ray diffraction image of first superconducting material joining layer 40 (RE3=Gd) shown in FIG. 6 after the fine crystal generating step (S20), i.e., after the step (S23) of thermally decomposing the carbon compound included in the calcined film, the carbon compound such as BaCO₃ included in the calcined film is thermally decomposed and RE3₁Ba₂Cu₃O_{y3} (RE3=Gd) is generated after the step (S23) of thermally decomposing the carbon compound included in the calcined film. A ring-shaped diffraction pattern of RE3₁Ba₂Cu₃O_{y3} (103), which indicates randomly oriented fine crystals, is also observed.

As shown in FIG. 4, the method for manufacturing superconducting wire 1 in the present embodiment further includes placing second wire 20 on first wire 10 with the first fine crystals being interposed therebetween and on third wire 30 with the second fine crystals being interposed therebetween (S30). The placing of second wire 20 on first wire 10 with the first fine crystals being interposed therebetween and on third wire 30 with the second fine crystals being interposed therebetween includes: stacking first portion 17 of first wire 10 and second portion 27 of second wire 20 with the first fine crystals being interposed therebetween; and stacking third portion 28 of second wire 20 and fourth portion 38 of third wire 30 with the second fine crystals being interposed therebetween. Second wire 20 extends over first end surface 10e of first wire 10 and second end surface 30e of third wire 30. Second superconducting material layer 23 bridges between first portion 17 of first superconducting material layer 13 and fourth portion 38 of third superconducting material layer 33. Second end surface 30e faces first end surface 10e with space G being interposed between second end surface 30e and first end surface 10e. This space G may be more than or equal to 10 nm, may be more than or equal to 100 nm, or may be more than or equal to 1 μm. This space G may be less than 1 mm, may be less than or equal to 400 μm, or may be less than or equal to 100 μm.

The method for manufacturing superconducting wire 1 in the present embodiment further includes generating first superconducting material joining layer 40 and second superconducting material joining layer 42 from the first fine crystals and the second fine crystals respectively by applying pressure and heat onto first wire 10, the first fine crystals, second wire 20, the second fine crystals, and third wire 30 (S40). Specifically, a pressure applying jig is used to press first wire 10 and second wire 20 against each other so as to apply a pressure of more than or equal to 1 MPa onto first wire 10, the first fine crystals, and second wire 20. The pressure applying jig is used to press second wire 20 and third wire 30 against each other so as to apply a pressure of more than or equal to 1 MPa onto second wire 20, the second fine crystals, and third wire 30.

While applying the pressure to first wire 10, the first fine crystals, and second wire 20, first wire 10, the first fine crystals, and second wire 20 are heated at a third temperature under an atmosphere having a second oxygen concentration. While applying the pressure to second wire 20, the second fine crystals, and third wire 30, second wire 20, the second fine crystals, and third wire 30 are heated at the third temperature under the atmosphere having the second oxygen concentration. The third temperature is more than or equal to the second temperature, and is more than or equal to the temperature at which the oxide superconducting material for each of first superconducting material joining layer 40 and second superconducting material joining layer 42 is generated. The second oxygen concentration is lower than the first oxygen concentration. The second oxygen concentration may be 100 ppm, for example.

In this heat pressing step (S40), the first fine crystals and second fine crystals generated in the calcined film thermal decomposing step (S23) are grown to generate first superconducting material joining layer 40 and second superconducting material joining layer 42 both composed of crystals having large grain sizes. The first fine crystals are grown along at least one crystal orientation of first superconducting material layer 13 and second superconducting material layer 23 on which the film has been formed in the film forming step (S21), and is accordingly formed into first superconducting material joining layer 40. The second fine crystals are grown along at least one crystal orientation of second superconducting material layer 23 and third superconducting material layer 33 on which the film has been formed in the film forming step (S21), and is accordingly formed into second superconducting material joining layer 42. In this way, first superconducting material layer 13 of first wire 10 and second superconducting material layer 23 of second wire 20 are joined to each other with first superconducting material joining layer 40 being interposed therebetween. Second superconducting material layer 23 of second wire 20 and third superconducting material layer 33 of third wire 30 are joined to each other with second superconducting material joining layer 42 being interposed therebetween.

In a two-dimensional X-ray diffraction image of first superconducting material joining layer 40 (RE3=Gd) shown in FIG. 7 after the heat and pressure applying step (S40), no ring-shaped diffraction pattern of RE3₁Ba₂Cu₃O_{y3} (103), which indicates randomly oriented fine crystals, is observed. Thus, it is understood that as a result of the heat and pressure applying step (S40), the randomly orientated first fine crystals are grown and first superconducting material joining layer 40 having an orientation is formed.

The method for manufacturing superconducting wire 1 in the present embodiment further includes performing oxygen annealing onto first superconducting material layer 13, first superconducting material joining layer 40, second superconducting material layer 23, second superconducting material joining layer 42, and third superconducting material layer 33 (S50). The oxygen annealing step (S50) is performed at a fourth temperature under an atmosphere having a third oxygen concentration. The fourth temperature is less than or equal to the third temperature. The fourth temperature may be more than or equal to 200° C. and less than or equal to 500° C. The third oxygen concentration is higher than the second oxygen concentration. The third oxygen concentration may be 100% (oxygen partial pressure of 1 atm), for example. Since space G between first end surface 10e and second end surface 30e is more than or equal to 10 nm, in the oxygen annealing step (S50), oxygen can be sufficiently supplied in a short time to first superconducting material layer 13, first superconducting material joining layer 40, second superconducting material layer 23, second superconducting material joining layer 42, and third superconducting material layer 33. With the above steps, superconducting wire 1 of the present embodiment can be manufactured.

The following describes effects of superconducting wire 1 and the method for manufacturing superconducting wire 1 in the present embodiment.

A superconducting wire 1 according to the present embodiment includes: a first wire 10 including a first superconducting material layer 13 having a first main surface 13s; a second wire 20 including a second superconducting material layer 23 having a second main surface 23s; a third wire 30 including a third superconducting material layer 33 having a third main surface 33s; a first superconducting material joining layer 40 that joins a first portion 17 of first main surface 13s to a second portion 27 of second main surface 23s; and a second superconducting material joining layer 42 that joins a third portion 28 of second main surface 23s to a fourth portion 38 of third main surface 33s. First wire 10 has a first end surface 10e. Third wire 30 has a second end surface 30e. A second length of second wire 20 in a longitudinal direction of second wire 20 is shorter than a first length of first wire 10 in a longitudinal direction of first wire 10 and a third length of third wire 30 in a longitudinal direction of third wire 30. Second end surface 30e faces first end surface 10e with a space G being interposed between second end surface 30e and first end surface 10e. Space G is more than or equal to 10 nm and less than 1 mm.

Superconducting wire 1 of the present embodiment is configured such that since space G between first end surface 10e and second end surface 30e is more than or equal to 10 nm, in the oxygen annealing step (S50), oxygen can be sufficiently supplied to first superconducting material joining layer 40, second superconducting material joining layer 42, first superconducting material layer 13, second superconducting material layer 23, and third superconducting material layer 33. Superconducting critical current I_{c} is increased at a first superconducting joining portion between first superconducting material layer 13 and second superconducting material layer 23 with first superconducting material joining layer 40 being interposed therebetween, and superconducting critical current I_{c} is increased at a second superconducting joining portion between second superconducting material layer 23 and third superconducting material layer 33 with second superconducting material joining layer 42 being interposed therebetween. Superconducting critical current I_{c} of superconducting wire 1 of the present embodiment is increased.

Since space G between first end surface 10e and second end surface 30e is less than 1 mm, a first joining area of the first superconducting joining portion can be increased between first superconducting material layer 13 and second superconducting material layer 23 with first superconducting material joining layer 40 being interposed therebetween, and a second joining area of the second superconducting joining portion can be increased between second superconducting material layer 23 and third superconducting material layer 33 with second superconducting material joining layer 42 being interposed therebetween. First detachment strength is increased between first wire 10 and second wire 20 and second detachment strength is increased between second wire 20 and third wire 30 in superconducting wire 1 of the present embodiment.

It should be noted that in superconducting wire 1 of the present embodiment, first wire 10 and third wire 30 may be the same wire. For example, first portion 17 of first wire 10 may constitute one end portion of one wire and fourth portion 38 of third wire 30 may constitute the other end portion of the wire.

In superconducting wire 1 according to the present embodiment, first superconducting material layer 13 is exposed at first end surface 10e. Third superconducting material layer 33 is exposed at second end surface 30e. Therefore, superconducting wire 1 according to the present embodiment is configured such that in the oxygen annealing step (S50), oxygen can be sufficiently supplied to first superconducting material joining layer 40, second superconducting material joining layer 42, first superconducting material layer 13, second superconducting material layer 23, and third superconducting material layer 33. Superconducting critical current I_{c} of superconducting wire 1 of the present embodiment is increased.

Superconducting wire 1 according to the present embodiment further includes a first conductive member 50 and a second conductive member 52. First wire 10 includes a first protective layer 14 in contact with first superconducting material layer 13, and a first stabilization layer 15 in contact with first protective layer 14. Second wire 20 includes a second protective layer 24, and a second stabilization layer 25 in contact with second protective layer 24. Third wire 30 includes a third protective layer 34 in contact with third superconducting material layer 33, and a third stabilization layer 35 in contact with third protective layer 34. First conductive member 50 connects first protective layer 14 to second protective layer 24, and connects first stabilization layer 15 to second stabilization layer 25. Second conductive member 52 connects second protective layer 24 to third protective layer 34, and connects second stabilization layer 25 to third stabilization layer 35.

Each of first protective layer 14, second protective layer 24, third protective layer 34, first stabilization layer 15, second stabilization layer 25, third stabilization layer 35, first conductive member 50, and second conductive member 52 functions as a bypass through which current having flown through first superconducting material layer 13, second superconducting material layer 23, third superconducting material layer 33, first superconducting material joining layer 40, and second superconducting material joining layer 42 is changed to flow when at least one of first superconducting material layer 13, second superconducting material layer 23, third superconducting material layer 33, first superconducting material joining layer 40, and the second superconducting material joining layer 42 makes transition from the superconducting state to the normal conducting state. Superconducting wire 1 can be prevented from being damaged when at least one of first superconducting material layer 13, second superconducting material layer 23, third superconducting material layer 33, first superconducting material joining layer 40, and second superconducting material joining layer 42 makes transition from the superconducting state to the normal conducting state.

A method for manufacturing a superconducting wire 1 according to the present embodiment includes: preparing a first wire 10 including a first superconducting material layer 13 having a first main surface 13s, a second wire 20 including a second superconducting material layer 23 having a second main surface 23s, and a third wire 30 including a third superconducting material layer 33 having a third main surface 33s (S10). First wire 10 has a first end surface 10e. Third wire 30 has a second end surface 30e. A second length of second wire 20 in a longitudinal direction of second wire 20 is shorter than a first length of first wire 10 in a longitudinal direction of first wire 10 and a third length of third wire 30 in a longitudinal direction of third wire 30. The method for manufacturing superconducting wire 1 according to the present embodiment further includes: forming first fine crystals on at least one of a first portion 17 of first main surface 13s and a second portion 27 of second main surface 23s, and forming second fine crystals on at least one of a third portion 28 of second main surface 23s and a fourth portion 38 of third main surface 33s (S20); and placing second wire 20 on first wire 10 with the first fine crystals being interposed therebetween and on third wire 30 with the second fine crystals being interposed therebetween (S30). The placing of second wire 20 on first wire 10 with the first fine crystals being interposed therebetween and on third wire 30 with the second fine crystals being interposed therebetween (S30) includes stacking first portion 17 of first wire 10 and second portion 27 of second wire 20 with the first fine crystals being interposed therebetween, and stacking third portion 28 of second wire 20 and fourth portion 38 of third wire 30 with the second fine crystals being interposed therebetween. Second end surface 30e faces first end surface 10e with a space G being interposed between second end surface 30e and first end surface 10e. Space G is more than or equal to 10 nm and less than 1 mm. The method for manufacturing superconducting wire 1 according to the present embodiment further includes: generating a first superconducting material joining layer 40 and a second superconducting material joining layer 42 from the first fine crystals and the second fine crystals respectively by applying pressure and heat to first wire 10, the first fine crystals, second wire 20, the second fine crystals, and third wire 30 (S40); and performing oxygen annealing onto first superconducting material layer 13, first superconducting material joining layer 40, second superconducting material layer 23, second superconducting material joining layer 42, and third superconducting material layer 33 (S50).

In the method for manufacturing superconducting wire 1 in the present embodiment, space G between first end surface 10e and second end surface 30e is more than or equal to 10 nm. Hence, in the oxygen annealing step (S50), oxygen can be sufficiently supplied in a short time to first superconducting material layer 13, first superconducting material joining layer 40, second superconducting material layer 23, second superconducting material joining layer 42, and third superconducting material layer 33. Superconducting critical current I_{c} is increased at a first superconducting joining portion between first superconducting material layer 13 and second superconducting material layer 23 with first superconducting material joining layer 40 being interposed therebetween, and superconducting critical current I_{c} is increased at a second superconducting joining portion between second superconducting material layer 23 and third superconducting material layer 33 with second superconducting material joining layer 42 being interposed therebetween. According to the method for manufacturing superconducting wire 1 in the present embodiment, superconducting wire 1 in which superconducting critical current I_{c} is increased can be manufactured in a short time.

In the method for manufacturing superconducting wire 1 in the present embodiment, space G between first end surface 10e and second end surface 30e is less than 1 mm. Hence, a first joining area of the first superconducting joining portion can be increased between first superconducting material layer 13 and second superconducting material layer 23 with first superconducting material joining layer 40 being interposed therebetween, and a second joining area of the second superconducting joining portion can be increased between second superconducting material layer 23 and third superconducting material layer 33 with second superconducting material joining layer 42 being interposed therebetween. According to the method for manufacturing superconducting wire 1 in the present embodiment, there can be manufactured superconducting wire 1 in which first detachment strength is increased between first wire 10 and second wire 20 and second detachment strength is increased between second wire 20 and third wire 30.

It should be noted that in the method for manufacturing superconducting wire 1 in the present embodiment, first wire 10 and third wire 30 may be the same wire. For example, first portion 17 of first wire 10 may constitute one end portion of one wire and fourth portion 38 of third wire 30 may constitute the other end portion of the wire.

### Second Embodiment

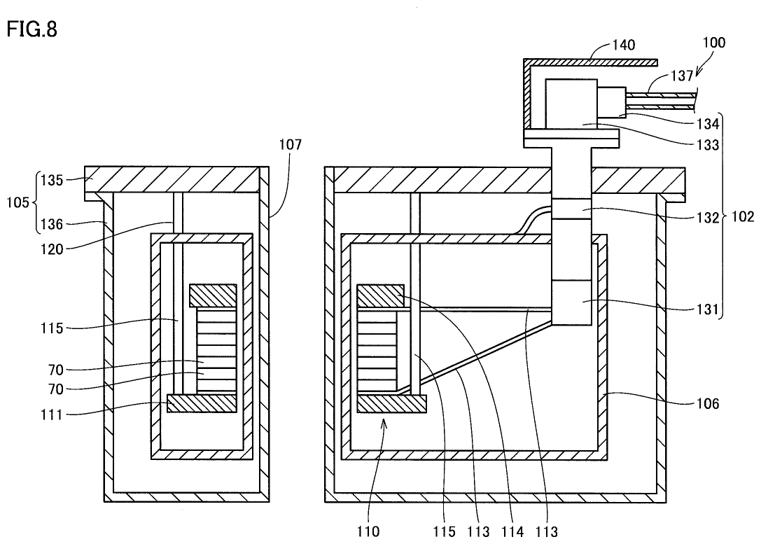

A superconducting magnet 100 of a second embodiment will be described with reference to FIG. 8.

Superconducting magnet 100 of the present embodiment mainly includes: a superconducting coil 70 including superconducting wire 1 of the first embodiment; a cryostat 105 configured to store superconducting coil 70; and a refrigerator 102 configured to cool superconducting coil 70. Particularly, superconducting magnet 100 may further include: a heat shield 106 retained in cryostat 105; and a magnetic body shield 140.

In superconducting coil 70, superconducting wire 1 is wound around the center axis of superconducting coil 70. A superconducting coil body 110 including superconducting coil 70 is stored in cryostat 105. Superconducting coil body 110 is retained in heat shield 106. Superconducting coil body 110 includes a plurality of the superconducting coils 70, an upper supporting portion 114, and a lower supporting portion 111. The plurality of superconducting coils 70 are layered. Upper supporting portion 114 and lower supporting portion 111 are disposed to sandwich the upper end surface and lower end surface of layered superconducting coils 70.

Cooling plates 113 are disposed on the upper end surface and lower end surface of layered superconducting coils 70. Cooling plates (not shown) are also disposed between adjacent superconducting coils 70. Each of cooling plates 113 has one end connected to a second cooling head 131 of refrigerator 102. Each of the cooling plates (not shown) disposed between adjacent superconducting coils 70 also has one end connected to second cooling head 131. A first cooling head 132 of refrigerator 102 may be connected to a wall portion of heat shield 106. Accordingly, the wall portion of heat shield 106 can be also cooled by refrigerator 102.

Lower supporting portion 111 of superconducting coil body 110 has a size larger than the planar shape of superconducting coil 70. Lower supporting portion 111 is fixed to heat shield 106 by a plurality of supporting members 115. Each of the plurality of supporting members 115 is a bar-like member, and connects the upper wall of heat shield 106 to the outer peripheral portion of lower supporting portion 111. Each of the plurality of supporting members 115 is disposed at the outer peripheral portion of superconducting coil body 110. Supporting members 115 are disposed to surround superconducting coil 70 with the same space being interposed therebetween.

Heat shield 106 retaining superconducting coil body 110 is connected to cryostat 105 by connection portions 120. Connection portions 120 are disposed at an equal interval along the outer peripheral portion of superconducting coil body 110 so as to surround the center axis of superconducting coil body 110. Connection portion 120 connects a cover body 135 of cryostat 105 to the upper wall of heat shield 106.

Refrigerator 102 is disposed to extend from an upper portion of cover body 135 of cryostat 105 to inside of heat shield 106. Refrigerator 102 cools superconducting coil body 110. Specifically, a main body portion 133 and a motor 134 of refrigerator 102 are disposed above the upper surface of cover body 135. Refrigerator 102 is disposed to extend from main body portion 133 to reach the inside of heat shield 106.

Refrigerator 102 may be a Gifford-McMahon refrigerator, for example. Refrigerator 102 is connected, via a pipe 137, to a compressor (not shown) for compressing refrigerant. The refrigerant (for example, helium gas) compressed by the compressor to have a high pressure is supplied to refrigerator 102. This refrigerant is expanded by a displacer driven by motor 134, thereby cooling a cold storage material provided inside refrigerator 102. The refrigerant expanded to have a low pressure is returned to the compressor and is provided with a high pressure again.

Since first cooling head 132 of refrigerator 102 cools heat shield 106, external heat is prevented from coming into heat shield 106. Second cooling head 131 of refrigerator 102 cools superconducting coils 70 via cooling plates 113. In this way, each superconducting coil 70 is brought into the superconducting state.

Cryostat 105 includes a cryostat main body portion 136 and cover body 135. Main body portion 133 and motor 134 are surrounded by magnetic body shield 140. Magnetic body shield 140 can prevent part of a magnetic field, generated from superconducting coil body 110, from coming into motor 134.

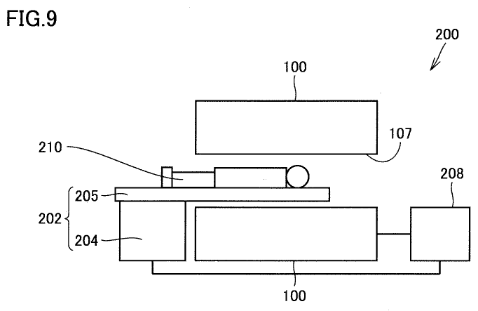

Superconducting magnet 100 is provided with an opening 107 that extends from cover body 135 of cryostat 105 to the bottom wall of cryostat main body portion 136 through cryostat 105 and heat shield 106. Opening 107 is disposed to extend therethrough at the central portion of superconducting coil 70 of superconducting coil body 110. A detection target 210 (see FIG. 9) can be laid inside opening 107, and a magnetic field generated from superconducting coil body 110 can be applied to detection target 210.

The following describes an effect of superconducting coil 70 of the present embodiment. A superconducting coil 70 of the present embodiment includes a superconducting coil 70 including superconducting wire 1. Superconducting wire 1 is wound around a center axis of the superconducting coil. Accordingly, superconducting coil 70 of the present embodiment has high reliability and can generate a strong magnetic field.

The following describes an effect of superconducting magnet 100 of the present embodiment. A superconducting magnet 100 of the present embodiment includes: superconducting coil 70 including superconducting wire 1; a cryostat 105 configured to store superconducting coil 70; and a refrigerator 102 configured to cool superconducting coil 70. Accordingly, superconducting magnet 100 of the present embodiment has high reliability and can generate a strong magnetic field.

### Third Embodiment

A superconducting device 200 of a third embodiment will be described with reference to FIG. 9. Superconducting device 200 of the present embodiment may be a magnetic resonance imaging (MRI) device, for example.

Superconducting device 200 of the present embodiment mainly includes superconducting magnet 100 of the second embodiment. Superconducting device 200 of the present embodiment may further include a movable base 202 and a controller 208. Movable base 202 includes: a top plate 205 on which a detection target 210 is laid; and a driving unit 204 configured to move top plate 205. Controller 208 is connected to superconducting magnet 100 and driving unit 204.

Controller 208 drives superconducting magnet 100 to generate a uniform magnetic field in opening 107 of superconducting magnet 100. Controller 208 moves movable base 202 so as to move detection target 210 laid on movable base 202 into opening 107 of superconducting magnet 100. When image capturing of detection target 210 is finished, controller 208 moves movable base 202 so as to move detection target 210 laid on movable base 202 out of opening 107 of superconducting magnet 100.

The following describes an effect of superconducting device 200 of the present embodiment. A superconducting device 200 of the present embodiment includes superconducting magnet 100. Accordingly, superconducting device 200 of the present embodiment has high reliability and can generate a strong magnetic field. Images of detection target 210 can be captured with precision using superconducting device 200 of the present embodiment.

The embodiments disclosed herein are illustrative and non-restrictive in any respect. The scope of the present invention is defined by the terms of the claims, rather than the embodiments described above, and is intended to include any modifications within the scope and meaning equivalent to the terms of the claims.

### REFERENCE SIGNS LIST

1: superconducting wire; 10: first wire; 10e: first end surface; 11: first metal substrate; 12: first intermediate layer; 13: first superconducting material layer; 13s: first main surface; 14: first protective layer; 15: first stabilization layer; 17: first portion; 20: second wire; 21: second metal substrate; 22: second intermediate layer; 23: second superconducting material layer; 23s: second main surface; 24: second protective layer; 25: second stabilization layer; 27: second portion; 28: third portion; 30: third wire; 30e: second end surface; 31: third metal substrate; 32: third intermediate layer; 33: third superconducting material layer; 33s: third main surface; 34: third protective layer; 35: third stabilization layer; 38: fourth portion; 40: first superconducting material joining layer; 42: second superconducting material joining layer; 50: first conductive member; 52: second conductive member; 70: superconducting coil; 100: superconducting magnet; 102: refrigerator; 105: cryostat; 106: heat shield; 107: opening; 110: superconducting coil body; 111: lower supporting portion; 113: cooling plate; 114: upper supporting portion; 115: supporting member; 120: connection portion; 131: second cooling head; 132: first cooling head; 133: main body portion; 134: motor; 135: cover body; 136: cryostat main body portion; 137: pipe; 140: magnetic body shield; 200: superconducting device; 202: movable base; 204: driving unit; 205: top plate; 208: controller; 210: detection target.

1. A superconducting wire comprising:
a first wire including a first superconducting material layer having a first main surface, the first wire having a first end surface;
a second wire including a second superconducting material layer having a second main surface;
a third wire including a third superconducting material layer having a third main surface, the third wire having a second end surface;
a first superconducting material joining layer that joins a first portion of the first main surface to a second portion of the second main surface; and
a second superconducting material joining layer that joins a third portion of the second main surface to a fourth portion of the third main surface, wherein
a second length of the second wire in a longitudinal direction of the second wire is shorter than a first length of the first wire in a longitudinal direction of the first wire and a third length of the third wire in a longitudinal direction of the third wire, and
the second end surface faces the first end surface with a space being interposed between the second end surface and the first end surface, and the space is more than or equal to 10 nm and less than 1 mm.

2. The superconducting wire according to claim 1, wherein
the first superconducting material layer is exposed at the first end surface, and
the third superconducting material layer is exposed at the second end surface.

3. The superconducting wire according to claim 1 further comprising:
a first conductive member; and
a second conductive member, wherein
the first wire includes a first protective layer in contact with the first superconducting material layer, and a first stabilization layer in contact with the first protective layer,
the second wire includes a second protective layer, and a second stabilization layer in contact with the second protective layer,
the third wire includes a third protective layer in contact with the third superconducting material layer, and a third stabilization layer in contact with the third protective layer,
the first conductive member connects the first protective layer to the second protective layer, and connects the first stabilization layer to the second stabilization layer, and
the second conductive member connects the second protective layer to the third protective layer, and connects the second stabilization layer to the third stabilization layer.

4. A method for manufacturing a superconducting wire, the method comprising:
preparing a first wire including a first superconducting material layer having a first main surface, a second wire including a second superconducting material layer having a second main surface, and a third wire including a third superconducting material layer having a third main surface, the first wire having a first end surface, the third wire having a second end surface, a second length of the second wire in a longitudinal direction of the second wire being shorter than a first length of the first wire in a longitudinal direction of the first wire and a third length of the third wire in a longitudinal direction of the third wire;
forming first fine crystals on at least one of a first portion of the first main surface and a second portion of the second main surface, and second fine crystals on at least one of a third portion of the second main surface and a fourth portion of the third main surface;
placing the second wire on the first wire with the first fine crystals being interposed therebetween and on the third wire with the second fine crystals being interposed therebetween, the placing of the second wire on the first wire with the first fine crystals being interposed therebetween and on the third wire with the second fine crystals being interposed therebetween including stacking the first portion of the first wire and the second portion of the second wire with the first fine crystals being interposed therebetween, and stacking the third portion of the second wire and the fourth portion of the third wire with the second fine crystals being interposed therebetween, the second end surface facing the first end surface with a space being interposed between the second end surface and the first end surface, the space being more than or equal to 10 nm and less than 1 mm;
generating a first superconducting material joining layer and a second superconducting material joining layer from the first fine crystals and the second fine crystals respectively by applying pressure and heat to the first wire, the first fine crystals, the second wire, the second fine crystals, and the third wire; and
performing oxygen annealing onto the first superconducting material layer, the first superconducting material joining layer, the second superconducting material layer, the second superconducting material joining layer, and the third superconducting material layer.

5. A superconducting coil having a center axis, the superconducting coil comprising the superconducting wire recited in claim 1, wherein the superconducting wire is wound around the center axis.

6. A superconducting magnet comprising:
the superconducting coil recited in claim 5;
a cryostat configured to store the superconducting coil; and
a refrigerator configured to cool the superconducting coil.

7. A superconducting device comprising the superconducting magnet recited in claim 6.
